(19) United States
(12) Patent Application Publication
(10) Pub. No.: US 2019/0130082 A1
(43) Pub. Date: May 2, 2019

(54) Authentication Methods and Devices for Allowing Access to Private Data

(71) Applicant: Motorola Mobility LLC, Chicago, IL (US)

(72) Inventors: Rachid Alameh, Crystal Lake, IL (US); Jarrett Simerson, Glenview, IL (US); Thomas Merrell, Beach Park, IL (US); Amitkumar Balar, Mundelein, IL (US)

(21) Appl. No.: 15/795,074

(22) Filed: Oct. 26, 2017

(51) Int. Cl. G06F 21/32; G06F 21/62; G06K 9/00; H04L 9/32; H04L 9/08; G10L 17/22

(52) U.S. Cl. CPC G06F 21/32; G06F 21/6218; G06K 9/00221; G10L 17/22; H04L 9/3231; H04L 9/0869; H04L 9/3228

(57) ABSTRACT

An electronic device includes at least one biometric sensor, at least one additional sensor, and a user interface. One or more processors are operable with a memory, carried by the electronic device and storing private data as encrypted private data. When a request to expose the private data is received, the one or more processors identify a requestor as a predetermined user by obtaining at least one biometric authentication factor and at least one second authentication factor. The one or more processors confirm the at least one biometric authentication factor and the at least one second authentication factor each match a predefined criterion. Where they do, the one or more processors expose the private data locally on the electronic device.

### BACKGROUND

### Technical Field

This disclosure relates generally to electronic devices, and more particularly to user authentication in electronic devices.

### Background Art

Not so very long ago, the thought of being able to carry a telephone in a pocket seemed like science fiction. Today, however, a smartphone not much bigger than an index card slips easily into the pocket and has more computing power than the most powerful desktop computers of a decade ago.

With all of this computing power, users of smartphones and other electronic devices rely on the same to perform an ever-increasing number of tasks. In addition to voice, text, and multimedia communication, users employ smartphones to execute financial transactions, record, analyze, and store medical information, store pictorial records of their lives, maintain calendar, to-do, and contact lists, and even perform personal assistant functions. To perform such a vast array of functions, these devices record substantial amounts of “private” data about the user, including their location, travels, health status, activities, friends, and more.

With such personal information stored in the device, it is desirable to ensure that only the user—or those authorized by the user—have access to this data. At the same time, it is desirable to provide for a simple, quick, and easy user interface that allows for quick access to the device. It would be advantageous to have an improved user interface for authenticating the user.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system and method in accordance with one or more embodiments of the disclosure.

FIG. 2 illustrates one explanatory system in accordance with one or more embodiments of the disclosure.

FIG. 3 illustrates explanatory components of one explanatory system in accordance with one or more embodiments of the disclosure.

FIG. 4 illustrates one or more explanatory method steps in accordance with one or more embodiments of the disclosure.

FIG. 5 illustrates one explanatory method in accordance with one or more embodiments of the disclosure.

FIG. 6 illustrates one or more explanatory method steps in accordance with one or more embodiments of the disclosure.

FIG. 7 illustrates one or more explanatory method steps in accordance with one or more embodiments of the disclosure.

FIG. 8 illustrates one or more explanatory method steps in accordance with one or more embodiments of the disclosure.

FIG. 9 illustrates one or more explanatory method steps in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to authenticating a user with a combination of biometric and non-biometric authentication factors as a condition precedent to exposing private data at a user interface of the electronic device. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of determining whether a biometric authentication factor and at least one second authentication factor, which may or may not be biometric, identify an authorized user prior to exposing private data as described herein. The non-processor circuits may include, but are not limited to, a radio receiver, a radio transmitter, signal drivers, clock circuits, power source circuits, and user input devices. As such, these functions may be interpreted as steps of a method to perform authorized user authentication prior to exposing private data at a user interface of the electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially” and “about” are used to refer to dimensions, orientations, or alignments inclusive of manufacturing tolerances. Thus, a “substantially orthogonal” angle with a manufacturing tolerance of plus or minus two degrees would include all angles between 88 and 92, inclusive. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide electronic devices having memory stores where information designated by a user or otherwise considered to be “private” is accessible only at a user interface of the electronic device. Illustrating by example, a user may designate financial account information, health information, social security number, genome sequence, or other information as “private.” When this occurs, such data is stored locally in the electronic device in an encrypted state. To access the private information, the user must have physical access to the device and be authenticated as an authorized user. In some embodiments, decryption of the private data outside the device it is not permitted. This helps to ensure that personal, private data is not transferred to the “cloud” or other electronic devices without the user's knowledge.

In one or more embodiments, private data can be transferred from one device to another, or from an electronic device to the “cloud,” but only after a dual-authentication process has occurred. In one or more embodiments, this dual authentication requires two-authentication factor to be verified as corresponding to an authorized user, with at least one factor being a biometric factor. Examples of biometric factors include facial recognition from a two-dimensional image, a facial depth scan matching a reference facial map, a fingerprint match, and a voice print match. This two-factor authentication ensures that only an authorized user can access private data. Moreover, in one or more embodiments decryption of the private data can only occur at the local device, and after the two-factor authentication, which confirms that the person with physical access to the device is the authorized user.

In one or more embodiments, the private data is encrypted within the electronic device using a “random seed,” which is frequently just referred to as a “seed.” The hardware is equipped with a true random number generator that generates a random number that forms the basis of the seed. A “seed” refers to the random number that is used as the basis for encryption. Since the hardware generates a truly random number, the seed becomes a function of this random number.

Encryption devices that encrypt data, such as the private data mentioned above, use an encryption key to encode the data so that only devices having the key can decode the same. A “cipher” encrypts the data using the encryption key. For all practical purposes, decryption of the data is impossible without the encryption key. In more complex systems, the encryption key is generated by using a random number generator as a seed. Accordingly, to decrypt the data, a device must have access to the seed so that the encryption key can be obtained. Access to the seed allows a random number generator matching the encryptor to generate matching encryption keys, thereby decrypting the data.

The encryption key can be a function of multiple factors. For example, the seed can be combined with other data to generate the encryption key. Embodiments of the disclosure employ data representations corresponding to unique characteristics of an authorized user. Examples of such characteristics include fingerprint, iris features, facial shape, skin tone, hair color, eye color, facial mapping in three dimensions, iris scans, voice profile, and other factors. In addition to these unique characteristics, one or more embodiments of the disclosure employ non-biometric information, such as a personal identification number (PIN), a user's location, and so forth. Thus, embodiments of the disclosure require not only access to the seed, but that a particular authorized user both be biometrically authenticated and deliver a second authentication factor to the device prior to any private data being revealed.

Advantageously, embodiments of the disclosure require that an authorized user physically have access to an electronic device prior to private data being revealed or exposed. Additionally, in one or more embodiments a second authentication factor, which is received in addition to any biometric authentication factor, such as an iris scan, must be obtained as well. This secondary authentication factor confirms that the authorized user actually intends to reveal the private data. The use of the same prevents private data from being revealed in advertently from biometric authentication alone.

In one or more embodiments, an electronic device receives, with a user interface, a request to expose private data. In one or more embodiments, the data has been encrypted with an encryption key generated from a seed. In one or more embodiments, the seed is a truly random seed that is unique to the electronic device.

In one or more embodiments, the data has been encrypted with an encryption key generated from a combination of other factors, such as data representing a physical characteristic of the user and at least one second authentication factor. Once encrypted, the encrypted data is stored within a local memory carried by the electronic device.

In one or more embodiments, after receiving the request to expose the private data, which is encrypted in the memory, one or more processors operating in conjunction with one or more sensors work to identify a predetermined user within a local environment of the electronic device as a requestor of the request. In one or more embodiments, the one or more processors do this by obtaining, with a biometric sensor, at least one biometric authentication factor from the local environment of the electronic device. In one or more embodiments, the one or more processors further obtain, with another sensor, at least one second authentication factor from the local environment of the electronic device, such as an iris scan.

In one or more embodiments, the one or more processors then determine whether the at least one biometric authentication factor and the at least one second authentication factor match predefined criteria. For example, where the biometric authentication factor is a three-dimensional depth scan of the user, the one or more processors may compare this scan to one or more predefined facial maps stored in memory. Similarly, where the biometric authentication factor is a two-dimensional image, the one or more processors may compare this to one or more facial images stored in memory. Other examples of comparison and confirmation will be described below. Still others will be obvious to those of ordinary skill in the art having the benefit of this disclosure.

In one or more embodiments, where both the at least one biometric authentication factor and the at least one second authentication factor match the predefined criteria, the one or more processors expose, locally on the electronic device, the private data as decrypted private data. This can include decrypting the encrypted data using the encryption key, the biometric authentication factor, and the at least one secondary factor. Alternatively, in other embodiments, where both the at least one biometric authentication factor and the at least one second authentication factor match the predefined criteria, the one or more processors transfer the encrypted private data to another electronic device.

In one or more embodiments, usage of the private data within the electronic device, where that private data is not exposed, requires only the seed. Thus, if the private data is processed for whatever reason within the electronic device, it can be decrypted using only the encryption key. However, in one or more embodiments if the data is exposed, i.e., made visible to a user, a combination of the encryption key, a biometric authentication factor, and at least one other authentication factor is required. For example, exposure of the data may require the encryption key, a three-dimensional facial depth scan matching a stored facial map or an iris scan, and entry of a user identified passcode.

The same is true for data transfers—if the data is to be transferred to another device, a combination of the encryption key, a biometric authentication factor, and at least one other authentication factor is required. In one or more embodiments, even after receiving a combination of the seed, a biometric authentication factor, and at least one other authentication factor, the data is still transferred in an encrypted state.

Where the private data is to be transferred from one device to another, a one-time user generated passcode can be created that allows an authorized user to access the private data on the other device provided they have physical access to the other device. For example, if a user has private data stored in a smartphone and buys a newer model, they may desire to transfer the private information to the new device. Accordingly, in one or more embodiments, the user would generate a one-time passcode. The encrypted data could then be transferred to the new device, with the user entering the one-time passcode to have access to the same at the new device.

Embodiments of the disclosure contemplate that sometimes it will be necessary to transfer the private data to other devices for processing. It may be advantageous, for instance, to transfer the private data to the “cloud” for processing, thereby offloading processing tasks to larger machines. For example, due to processing limitations in the electronic device, machine learning, processing requiring the addition of information stored in the cloud, offline training, and so forth may be performed in the cloud. When the private data is required, it is transferred to the other machine in an encrypted state. In one or more embodiments, the private data is never decrypted outside of the electronic device.

This is true because, in one or more embodiments, decryption only occurs in the electronic device itself. Thus, in one or more embodiments, for the private data to be decrypted for any purpose, an authorized user must have physical access to the electronic device. The authorized user must further be authenticated with multiple factors. In one or more embodiments, at least one of the factors is a biometric factor. Thus, in one embodiment the authorized user may have to provide a fingerprint or iris can and allow their face to be scanned with a three -dimensional depth scanner. In another embodiment, the user may be authenticated with an iris scan and entry of a pass code. In yet another embodiment, a user may be authenticated with an iris scan in front of a known structure, owner vehicle license plate, or address on mailbox.

Accordingly, in one or more embodiments, only the authorized user can decrypt private information. This occurs only after the authorized user is authenticated. If an unauthorized person gets access to the electronic device, in one or more embodiments the authentication system fails to identify this person as an authorized user and disables the seed despite the fact that the person has access to the electronic device. For instance, image and voice recognition processing, combined with a location authentication factor, may determine that the person attempting to access the device is unauthorized. Where this occurs, the device may disable the encryption key access. In other embodiments, when an unauthorized user is detected, decryption of the private data may require additional authentication factors prior to any decryption occurring.

Advantageously, in one or more embodiments decryption of private data requires, at a minimum, physical access to the electronic device and authentication of a person as an authorized user. In one or more embodiments, this authentication of the person occurs continually. Thus, if an authorized user stops using an electronic device, or if an unauthorized user takes the electronic device away from the user, any private data will be removed from display, encrypted, and re -stored in memory. Optionally, the electronic device can be locked as well.

Thus, in one or more embodiments of the disclosure an electronic device holds an encryption key. The encryption key can be a function of a random number used as a seed associated with the electronic device. Additionally, in one or more embodiments the encryption key can be further a function of a combination of the seed or encryption key, a biometric authentication factor, and at least one other authentication factor. For example, exposure of the data may require the encryption key, a three-dimensional facial depth scan matching a stored facial map, an iris scan, and entry of a user identified passcode. As such, the encryption key becomes a user specific, truly random number. This means that the encryption key cannot be obtained from a different electronic device.

Moreover, in some embodiments, the encryption key is disabled if an unauthorized user is accessing the device. By contrast, when the authorized user is using the device, the encryption key is enabled. In one or more embodiments, the authorized user is authenticated by at least two authentication factors, with one being biometric. Examples include a facial recognition factor and a pass code, a facial depth scan factor and a pass code, a facial recognition factor and a voice recognition factor, a facial depth scan factor and a voice recognition factor, a facial recognition factor and a predefined location, a facial depth scan factor and a predefined location, an iris scan and a pass code, a phone orientation and predefined lighting, or a voice recognition factor, a predefined location or PIN, or a fingerprint sensor and pincode. Accordingly, in one or more embodiments private data can only be decrypted if a user holds the device in the right way, in the right location, at the right time of day, and while speaking the right incantation, e.g., pass code. Other authentication factors will be described below. Still others will be obvious to those of ordinary skill in the art having the benefit of this disclosure.

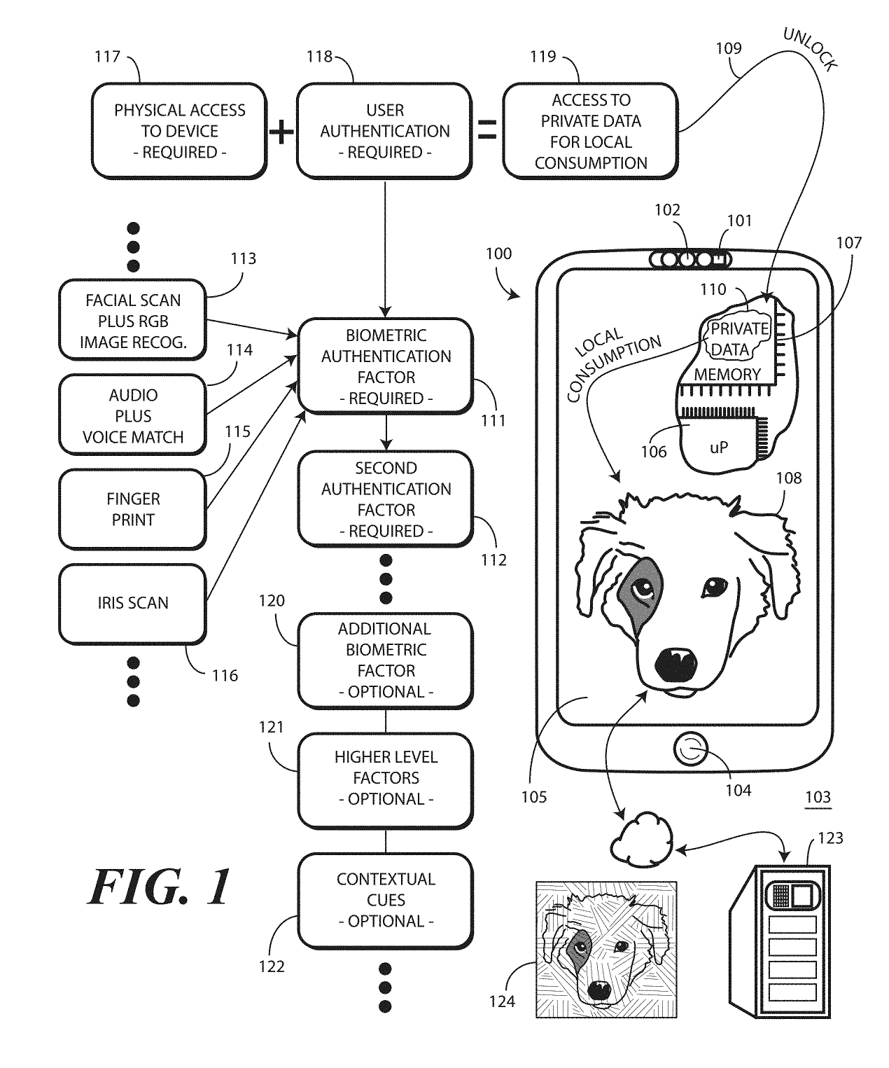

Turning now to FIG. 1, illustrated therein is one explanatory system in accordance with one or more embodiments of the disclosure. In this illustrative embodiment, an electronic device 100 includes at least one biometric sensor 101 and at least one additional sensor 102.

In one embodiment, the biometric sensor 101 comprises an imager operable to capture one or more images of an environment 103 of the electronic device 100. In another embodiment, the biometric sensor 101 comprises a depth imager operable to perform one or more depth scans of objects in the environment 103 of the electronic device 100. In still another embodiment, the biometric sensor 101 comprises an audio capture device operable to receive sounds from the environment 103 of the electronic device 100. In still other embodiments, the biometric sensor 101 comprises a fingerprint sensor 104. Of course, combinations of these can comprise the biometric sensor 101 as well. Thus, the biometric sensor 101 could comprise an imager, depth scan imager, and fingerprint sensor 104. Other examples of biometric sensors will be described in more detail below. Still others will be obvious to those of ordinary skill in the art having the benefit of this disclosure.

Where the biometric sensor 101 includes an imager, the imager can capture single images or an object in the environment 103 of the electronic device 100. Alternatively, it can capture a plurality of images of objects in the environment 103. In one or more embodiments, image(s) each comprise a two-dimensional image. For example, in one embodiment each image is a two -dimensional Red-Green-Blue (RGB) image. In another embodiment, each image is a two -dimensional infrared image. Other types of two-dimensional images will be obvious to those of ordinary skill in the art having the benefit of this disclosure.

The imager can be configured to capture an image of an environment 103 about the electronic device 100. The can optionally determine whether an object captured in an image matches predetermined criteria. For example, the imager can operate as an identification module configured with optical recognition such as include image recognition, character recognition, visual recognition, facial recognition, color recognition, shape recognition and the like.

Where the biometric sensor 101 includes a depth imager, this device is operable to capture at least one depth scan of the objects in the environment 103 of the electronic device 100. For example, the depth imager may capture a three-dimensional depth scan of a person's face when the person is situated within a predefined radius of the electronic device 100. The depth scan can be a single depth scan in one embodiment. Alternatively, the depth scan can comprise multiple depth scans of an object.

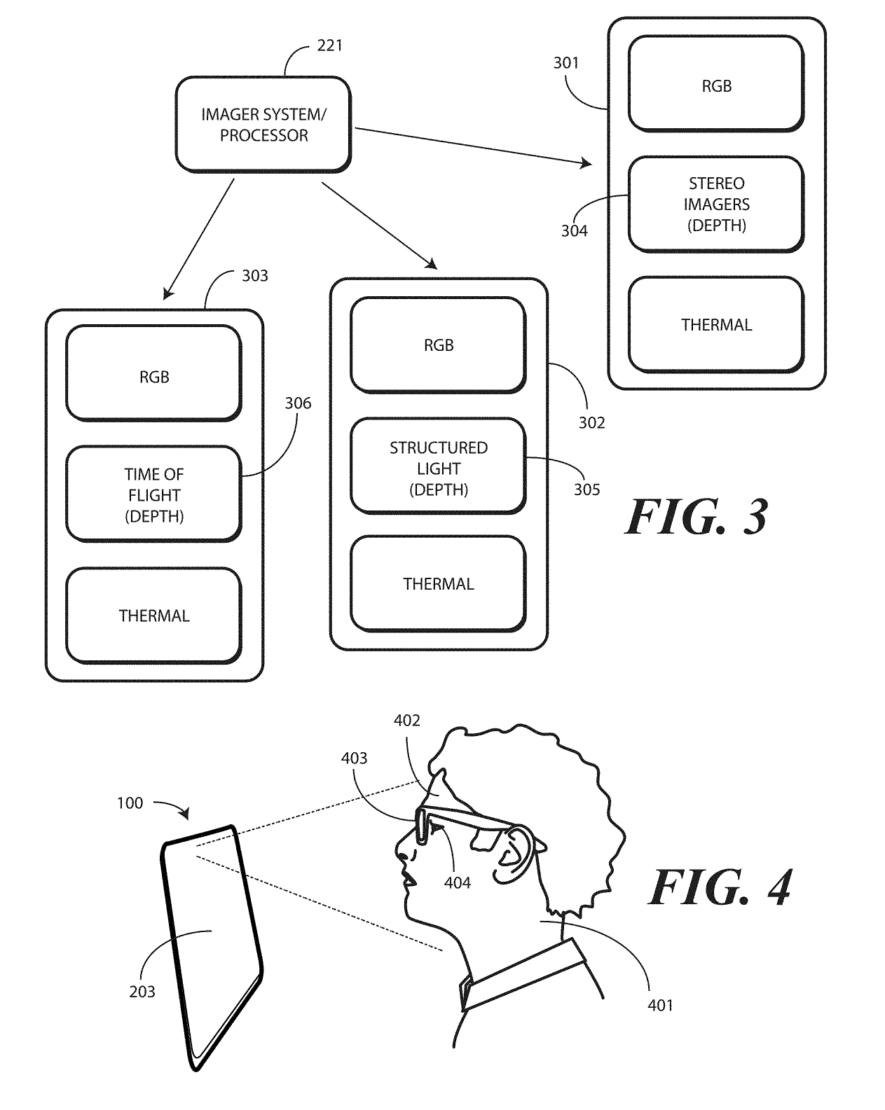

As will be described below in more detail with reference to FIG. 3, the depth imager 212 can take any of a number of forms. These include the use of stereo imagers, separated by a predefined distance, to create a perception of depth, the use of structured light lasers to scan patterns—visible or not—that expand with distance and that can be captured and measured to determine depth, time of flight sensors that determine how long it takes for an infrared or laser pulse to translate from the electronic device 100 an object in the environment 103 of the electronic device 100 and back. Other types of depth imagers will be obvious to those of ordinary skill in the art having the benefit of this disclosure.

In one or more embodiments, the depth scan can create a depth map of an object located within the environment 103 of the electronic device 100. Using a person's face as an example, in one or more embodiments the depth scan can create a three-dimensional facial depth map of a person. This depth map can then be compared to one or more predefined facial maps to confirm whether the contours, nooks, crannies, curvatures, and features of the person's are that of an authorized user of the electronic device 100, as identified by the one or more predefined facial maps.

The additional sensor 102 can take a variety of forms as well. In one or more embodiments, the additional sensor 102 can also be an imager. In addition to capturing biometric information as noted above, an imager can function in other non-biometric ways as well. For example, in some embodiments the imager can capture multiple successive pictures to capture more information that can be used to determine bearing and/or location. By referencing video or successive photographs with reference data, the imager, or one or more processors 106 operable with the imager, can determine, for example, whether the electronic device 100 is moving toward an object or away from another object. Alternatively, the imager, or one or more processors 106 operable with the imager, can compare the size of certain objects within captured images to other known objects to determine the size of the former. In still other embodiments, the imager, or one or more processors 106 operable with the imager, can capture images or video frames, with accompanying metadata such as motion vectors.

The additional sensor 102 can comprise one or more proximity sensors. The proximity sensors can include one or more proximity sensor components. The proximity sensors can also include one or more proximity detector components. In one embodiment, the proximity sensor components comprise only signal receivers. By contrast, the proximity detector components include a signal receiver and a corresponding signal transmitter.

While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

The additional sensor 102 can include an image stabilizer. The image stabilizer can be operable with motion detectors, such as an accelerometer and/or gyroscope to compensate for pan, rotation, and tilt of the electronic device 100, as well as dynamic motion in a three dimensional space, when an imager is capturing images. The image stabilizer can comprise an optical image stabilizer, or alternatively can be an electronic image stabilizer.

The additional sensor 102 can also include motion detectors, such as one or more accelerometers and/or gyroscopes. For example, an accelerometer may be used to show vertical orientation, constant tilt and/or whether the electronic device 100 is stationary. The measurement of tilt relative to gravity is referred to as “static acceleration,” while the measurement of motion and/or vibration is referred to as “dynamic acceleration.” A gyroscope can be used in a similar fashion. It should be noted that the imager can also serve as a motion detector by capturing one or more images and comparing one image to another for changes in scenery to detection motion.

The additional sensor 102 can comprise a gravity sensor used to determine the spatial orientation of the electronic device 100 by detecting a gravitational direction. In addition to, or instead of, the gravity sensor, an electronic compass can be included to detect the spatial orientation of the electronic device 100 relative to the earth's magnetic field.

The additional sensor 102 can comprise a light sensor to detect changes in optical intensity, color, light, or shadow in the environment 103 of the electronic device 100. This can be used to make inferences about whether the electronic device 100 is indoors or outdoors. An infrared sensor can be used in conjunction with, or in place of, the light sensor. The infrared sensor can be configured to detect thermal emissions from an environment about an electronic device, such as when sunlight is incident upon the electronic device.

The additional sensor 102 can comprise a magnetometer to detect the presence of external magnetic fields. The additional sensor 102 can also comprise an audio capture device, such as one or more microphones to receive acoustic input. The one or more microphones include a single microphone. In other embodiments, the one or more microphones can include two or more microphones. Where multiple microphones are included, they can be used for selective beam steering to, for instance, determine from which direction a sound emanated.

The additional sensor 102 can also comprise a location sensor. In some embodiments, the encryption key is disabled if an unauthorized user is accessing the device. By contrast, when the authorized user is using the device, the encryption key is enabled. In one or more embodiments, the authorized user is authenticated only when authenticated by at least two authentication factors, with one being biometric. Examples include a facial recognition factor and a pass code, a facial depth scan factor and a pass code, a facial recognition factor and a voice recognition factor, a facial depth scan factor and a voice recognition factor, a facial recognition factor and a predefined location, a facial depth scan factor and a predefined location, an iris scan and a pass code, a phone orientation and predefined lighting, or a voice recognition factor, a predefined location or PIN, or a fingerprint sensor and pin code. Accordingly, in one or more embodiments private data can only be decrypted if a user holds the device in the right way, in the right location, at the right time of day, and while speaking the right incantation, e.g., pass code.

The additional sensor 102 can also be a user interface, such as the touch-sensitive display 105 of the electronic device 100 shown in FIG. 1. Users can deliver information to the user interface, such as pass codes, PINs, or other information.

It should be noted that the listed options above for the biometric sensor 101 and the at least one additional sensor 102 are merely examples. Accordingly, the list of biometric sensors and other sensors is not intended to be comprehensive. Numerous others could be added, as numerous others will be obvious to those of ordinary skill in the art having the benefit of this disclosure. Additionally, it should be noted that the various biometric sensors and other sensors mentioned above could be used alone or in combination. Accordingly, many electronic devices will employ only subsets of these biometric sensors and other sensors, with the particular subset defined by device application.

As shown, an electronic device 100 includes one or more processors 106. The one or more processors 106 are operable with the at least one biometric sensor 101 and the at least one additional sensor 102 in one or more embodiments.

A memory 107, carried by the electronic device 100 and operable with the one or more processors 106, stores private data 108. The private data 108 could be anything identified as private by a user, understood to be private by the one or more processors 106, e.g., a fingerprint or pass code, or that is recorded to a private memory store within the memory 107. Illustrating by example, a user may designate a fingerprint, iris scan, social security number, genome sequence, or other information as “private.” Alternatively, the one or more processors 106 may be configured to understand that biometric or other information, such as fingerprints and iris scans, or personal identification information, such as social security numbers, constitute private information.

In one or more embodiments, the private data 108 is stored in the memory 107 as encrypted private data 110. Said differently, the private data 108 can be stored locally in the memory 107 of the electronic device 100 in an encrypted state. In one or more embodiments, decryption of the encrypted private data 110 is not permitted except locally within the electronic device 100, and only when an authorized user has physical access 117 to the electronic device 100 and is authenticated 118 as the authorized user. This helps to ensure that personal, private data is not transferred to the “cloud” or other electronic devices without the user's knowledge.

In one or more embodiments, the private data 108 is encrypted within the electronic device 100 using a random seed as the basis of an encryption key that is generated by the electronic device 100. A random number generator operable with the one or more processors 106 generates the random number seed to create one or more encryption keys to encrypt the private data 108. Accordingly, to decrypt the data, access to the random number seed is required so that the encryption key can be obtained.

In one or more embodiments, the private data 108 is encrypted with an encryption key that is a function not only of the seed, but of other factors as well. For example, the seed can be combined with other data to generate the encryption key. This data can be expressions of information captured by either or both of the biometric sensor 101 or the at least one additional sensor 102. For example, if the biometric sensor 101 captures a facial depth scan, this can be converted to a numeric representation that is combined with the seed to generate the encryption key. Similarly, if a facial recognition process is performed on an image captured by an imager, this can be converted to a numeric representation that is combined with the seed to generate the encryption key. Likewise, if a the biometric sensor 101 performs an iris scan, this can be converted to a numeric representation that is combined with the seed to generate the encryption key. Optionally, a location of the electronic device 100 can be converted to a numeric representation that is combined with the seed to generate the encryption key. Other examples of other factors include device orientation, lighting, and so forth, such that the private data 108 can only be decrypted if the user holds the electronic device 100 in the right way, in the right location, at the right time of day, and while speaking the right incantation or passphrase.

Accordingly, in one or more embodiments the ultimate basis of the encryption key, i.e., the seed modified by one or more additional factors, comprises a data representation corresponding to unique characteristics of an authorized user. Examples of such characteristics include fingerprint, iris features, facial shape, skin tone, hair color, eye color, iris scan, facial mapping in three dimensions, voice profile, and other factors. In addition to these unique characteristics, one or more embodiments of the disclosure employ non-biometric information, such as a personal identification number (PIN), a user's location, home, vehicle, and so forth.

Thus, embodiments of the disclosure require not only access to a key that is a function of the random number generated by the hardware, but that a particular authorized user both be biometrically authenticated and deliver a second authentication factor to the device prior to any private data 108 being revealed. In one or more embodiment, the seed comprises one or more of a facial recognition and/or facial depth scan combined with a PIN. In another embodiment, the seed comprises one or more of a facial recognition and/or facial depth scan combined with a voiceprint. Other examples of seeds will be obvious to those of ordinary skill in the art having the benefit of this disclosure.

When a user wishes to see, use, or obtain access to the private data 108, they deliver a request 109 to expose the private data 108. In one or more embodiments, the private data 108 is only accessible in a decrypted form locally at the electronic device 100. As such, in one or more embodiments, the request 109 comprises a request to expose the private data locally at the electronic device 100.

The one or more processors 106 then receive the request 109 to expose, i.e., decrypt and present, the encrypted private data 110 locally on the electronic device. In one or more embodiments, the one or more processors 106, in response to the request 109, attempt to identify the requestor as a predetermined user who is authorized to view, use, or access the private data 108. In one or more embodiments, the one or more processors 106 do this by obtaining at least one biometric authentication factor 111 with the at least one biometric sensor 101 and at least one second authentication factor 112 from the at least one additional sensor 102.

Each of the biometric authentication factor 111 and the at least one second authentication factor 112 can take a variety of forms. In one embodiment, a first biometric authentication factor 113 comprises performing a facial depth scan with a depth imager and performing a facial recognition process upon an RGB image captured by an imager.

Illustrating by example, in one or more embodiments the first biometric authentication factor 113 is a combination of two-dimensional imaging and depth scan imaging. Additional factors, such as thermal sensing and optionally one or more higher authentication factors can be included with the first biometric authentication factor 113 as well.

When using the first biometric authentication factor, an imager captures at least one image of an object situated within a predefined radius of the electronic device. The image can be a single image or a plurality of images. The image(s) can be compared to one or more predefined reference images stored in the memory 107. By making such a comparison, one or more processors 106 can confirm whether the shape, skin tone, eye color, hair color, hair length, and other features identifiable in a two-dimensional image are that of the authorized user identified by the one or more predefined reference images

In addition to the imager capturing the image, in one or more embodiments a depth imager captures at least one depth scan of the object when situated within the predefined radius of the electronic device 100. The depth scan can be a single depth scan or a plurality of depth scans of the object. The depth scan creates a depth map of a three-dimensional object, such as the user's face. This depth map can then be compared to one or more predefined facial maps stored in memory 107 to confirm whether the contours, nooks, crannies, curvatures, and features of the user's face are that of the authorized user identified by the one or more predefined facial maps.

In another embodiment, a second biometric authentication factor 114 comprises performing a voice analysis on captured audio to determine whether the audio matches predefined voice data to confirm that the voice in the audio is that of the authorized user identified by the one or more predefined voice data.

Illustrating by example, the one or more processors 106 can be operable with a voice control interface engine. The voice control interface engine can include hardware, executable code, and speech monitor executable code in one embodiment. The voice control interface engine can include, stored in memory 107, basic speech models, trained speech models, or other modules that are used by the voice control interface engine to receive voice input and compare that voice input to the models. In one embodiment, the voice control interface engine can include a voice recognition engine. Regardless of the specific implementation utilized in the various embodiments, the voice control interface engine can access various speech models to identify whether the speech came from an authorized user.

A third biometric authentication factor 115 can include authenticating a fingerprint of a user. For instance, the fingerprint sensor 104 can detect a finger touching the fingerprint sensor 104, and can capture and store fingerprint data from the finger. The one or more processors 106, or optionally auxiliary processors operable with the fingerprint sensor 104, can then identify or authenticate a user as an authorized user based upon the fingerprint data.

The fingerprint sensor 104 can include a plurality of sensors, such as complementary metal-oxide-semiconductor active pixel sensors or a digital imager, that capture a live scan of a fingerprint pattern from a finger disposed along its surface. This information can then be stored as fingerprint data from the user's finger. The fingerprint sensor 104 may also be able to capture one or more images with the plurality of sensors. The images can correspond to an area beneath a surface of skin. The fingerprint sensor 104 can compare the fingerprint data or skin images to one or more references stored in the memory 107 to authenticate a user in an authentication process.

A fourth biometric authentication factor 116 is an iris scan. An imager or other sensor can capture images or scans of the iris of a person to perform a retinal scan. Information such the retinal pattern of the eye can be ascertained from such an image. The one or more processor 106 can then compare the iris scan to one or more references stored in the memory 107 to authenticate a user as an authorized user in an authentication process.

As with the biometric authentication factor 111, the at least one second authentication factor 112 can take a variety of forms. In one embodiment, the at least one second authentication factor 112 comprises a passcode. In another embodiment, the at least one second authentication factor 112 comprises a PIN. In another embodiment, the at least one second authentication factor 112 comprises a voiceprint.

In still another embodiment, the at least one second authentication factor 112 comprises a location of the electronic device 100. For example, if the one or more processors 106 determine that the electronic device 100 is located at the home of an authorized user, this can serve as the at least one second authentication factor 112.

Thus, in one or more embodiments the seed is a combination of at least three elements:

the truly random number, the biometric authentication factor 111, and the at least one second authentication factor 112. As such, authorization 118 of an authorized user may include obtaining a facial scan and/or an image, combined with entry of a user PIN to construct the decryption seed in one embodiment. In another embodiment, authorization 118 of an authorized user may include obtaining a facial scan and/or an image, combined with the match of a voiceprint to a reference file to construct the decryption seed.

Higher-level factors 121 can be included with these three elements. For instance, a higher-level biometric factor 120 can be included with the at least one biometric authentication factor 111 and the at least one second authentication factor 112. Similarly, contextual cues 122, such as the location of the electronic device 100, can be used as well.

Where this authorization 118 fails to occur, the seed is disabled. This is true because any biometric factor and/or other factor received would be incorrect, and would fail to create the proper decryption key within the electronic device 100. Accordingly, only the authorized user can access private data 108.

In one or more embodiments, upon receiving a request 109 to expose the private data 108, the one or more processors 106 confirm the at least one biometric authentication factor 111 and the at least one second authentication factor 112 each match a predefined criterion. For example, where the biometric authentication factor is an image of a person's face, the one or more processors 106 may compare the image with the one or more predefined reference images stored in memory 107. Where the biometric authentication factor 111 comprises a facial depth scan, the one or more processors 106 may compare the depth scan with the one or more predefined facial maps stored in memory 107.

Authentication will fail in one or more embodiments unless the image sufficiently corresponds to at least one of the one or more predefined images and/or the depth scan sufficiently corresponds to at least one of the one or more predefined facial maps. As used herein, “sufficiently” means within a predefined threshold. For example, if one of the predefined images includes 500 reference features, such as facial shape, nose shape, eye color, hair color, skin color, and so forth, the image will sufficiently correspond to at least one of the one or more predefined images when a certain number of features in the image are also present in the predefined images. This number can be set to correspond to the level of security desired. Some users may want ninety percent of the reference features to match, while other users will be content if only eighty percent of the reference features match, and so forth.

As with the predefined images, the depth scan will sufficiently match the one or more predefined facial maps when a predefined threshold of reference features in one of the facial maps is met. In contrast to two-dimensional features found in the one or more predefined images, the one or more predefined facial maps will include three-dimensional reference features, such as facial shape, nose shape, eyebrow height, lip thickness, ear size, hair length, and so forth. As before, the depth scan will sufficiently correspond to at least one of the one or more predefined facial maps when a certain number of features in the depth scan are also present in the predefined facial maps. This number can be set to correspond to the level of security desired. Some users may want ninety-five percent of the reference features to match, while other users will be content if only eighty-five percent of the reference features match, and so forth.

The at least one second authentication factor 112 can be similarly analyzed. If the at least one second authentication factor 112 is a PIN, it can be compared to a reference PIN stored in memory 107. Similarly, if the at least one second authentication factor 112 is a passcode, this passcode can be compared to a reference passcode stored in memory 107.

If the at least one second authentication factor 112 is a voiceprint, the one or more processors 106 may compare the voiceprint with the one or more predefined reference audio files stored in memory 107. Authentication will fail in one or more embodiments unless the at least one second authentication factor 112 matches or sufficiently corresponds to at least one reference stored in memory 107.

When the at least one biometric authentication factor 111 and the at least one second authentication factor 112 each sufficiently match the predefined criterion, in one or more embodiments the one or more processors 106 expose 119 the private data 108 locally on the electronic device 100. In this embodiment, a picture of Buster is presented on the display 105.

Embodiments of the disclosure contemplate that sometimes it will be necessary to transfer the encrypted private data 110 to other devices 123 for processing. It may be advantageous, for instance, to transfer the private data to the “cloud” for processing, thereby offloading processing tasks to larger machines. For example, due to processing limitations in the electronic device, machine learning, processing requiring the addition of information stored in the cloud, offline training, and so forth may be performed in the cloud. When the encrypted private data 110 is required, it is transferred to the other machine in an encrypted state 124. In one or more embodiments, the encrypted private data 110 is never decrypted outside of the electronic device 100.

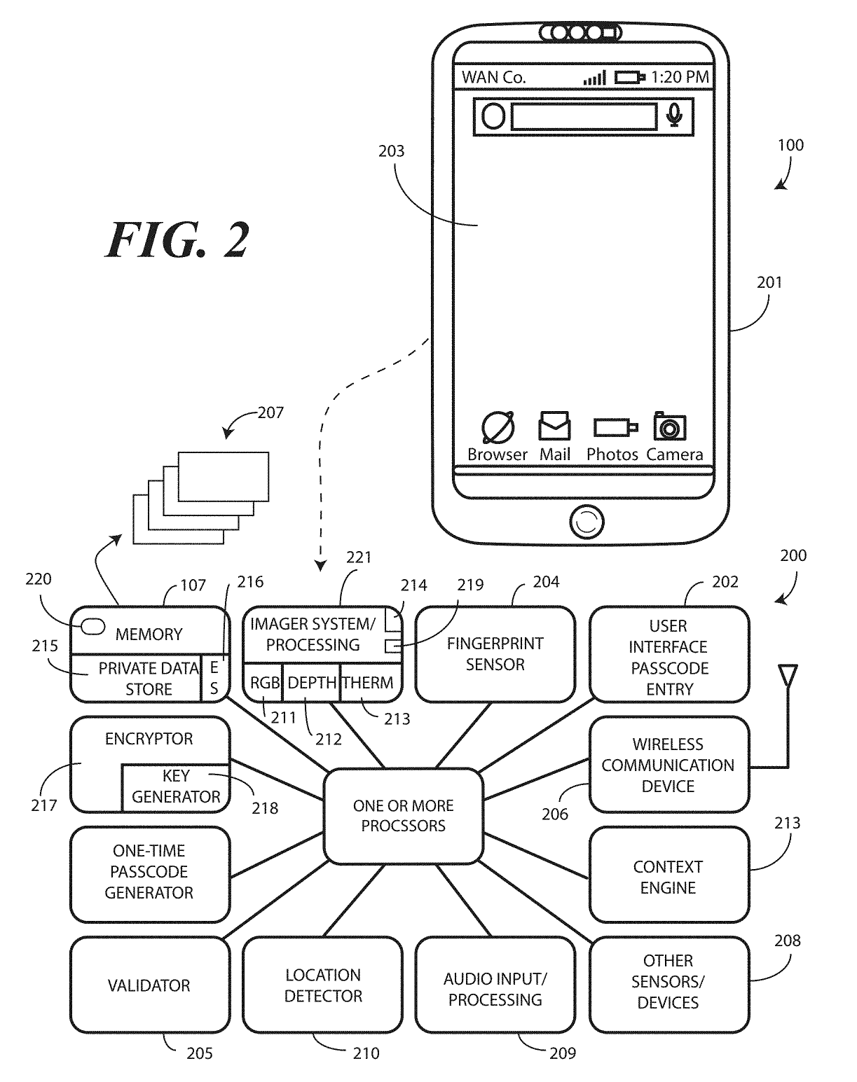

Turning now to FIG. 2, illustrated therein is one explanatory block diagram schematic 200 of one explanatory electronic device 100 configured in accordance with one or more embodiments of the disclosure. The electronic device 100 can be one of various types of devices. In one embodiment, the electronic device 100 is a portable electronic device, one example of which is a smartphone that will be used in the figures for illustrative purposes. However, it should be obvious to those of ordinary skill in the art having the benefit of this disclosure that the block diagram schematic 200 could be used with other devices as well, including conventional desktop computers, palm-top computers, tablet computers, gaming devices, media players, wearable devices, or other devices. Still other devices will be obvious to those of ordinary skill in the art having the benefit of this disclosure.

In one or more embodiments, the block diagram schematic 200 is configured as a printed circuit board assembly disposed within a housing 201 of the electronic device 100. Various components can be electrically coupled together by conductors or a bus disposed along one or more printed circuit boards.

The illustrative block diagram schematic 200 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

The illustrative block diagram schematic 200 includes a user interface 202. In one or more embodiments, the user interface 202 includes a display 203, which may optionally be touch -sensitive. In one embodiment, users can deliver user input to the display 203 of such an embodiment by delivering touch input from a finger, stylus, or other objects disposed proximately with the display 203. For example, a user can enter a PIN or passcode by delivering input to a virtual keyboard presented on the display 203.

In one embodiment, the display 203 is configured as an active matrix organic light emitting diode (AMOLED) display. However, it should be noted that other types of displays, including liquid crystal displays, suitable for use with the user interface 202 would be obvious to those of ordinary skill in the art having the benefit of this disclosure.

In one embodiment, the electronic device includes one or more processors 106. In one embodiment, the one or more processors 106 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 200. Each of the application processor and the auxiliary processor(s) can be configured to process and execute executable software code to perform the various functions of the electronic device with which the block diagram schematic 200 operates. A storage device, such as memory 107, can optionally store the executable software code used by the one or more processors 106 during operation.

In this illustrative embodiment, the block diagram schematic 200 also includes a communication circuit 206 that can be configured for wired or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks. The communication circuit 206 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology. The communication circuit 206 can include wireless communication circuitry, one of a receiver, a transmitter, or transceiver, and one or more antennas.

In one embodiment, the one or more processors 106 can be responsible for performing the primary functions of the electronic device with which the block diagram schematic 200 is operational. For example, in one embodiment the one or more processors 106 comprise one or more circuits operable with the user interface 202 to present presentation information to a user. The executable software code used by the one or more processors 106 can be configured as one or more modules 207 that are operable with the one or more processors 106. Such modules 207 can store instructions, control algorithms, and so forth.

In one or more embodiments, the block diagram schematic 200 includes an audio input/processor 209. The audio input/processor 209 can include hardware, executable code, and speech monitor executable code in one embodiment. The audio input/processor 209 can include, stored in memory 107, basic speech models, trained speech models, or other modules that are used by the audio input/processor 209 to receive and identify voice commands that are received with audio input captured by an audio capture device. In one embodiment, the audio input/processor 209 can include a voice recognition engine. Regardless of the specific implementation utilized in the various embodiments, the audio input/processor 209 can access various speech models to identify speech commands.

In one embodiment, the audio input/processor 209 is configured to implement a voice control feature that allows a user to speak a specific device command to cause the one or more processors 106 to execute a control operation. For example, the user may say, “Authenticate Me Now.” This statement comprises a device command requesting the one or more processors to cooperate with the facial biometric authenticator 221 to authenticate a user. Consequently, this device command can cause the one or more processors 106 to access the facial biometric authenticator 221 and begin the authentication process. In short, in one embodiment the audio input/processor 209 listens for voice commands, processes the commands and, in conjunction with the one or more processors 106, performs a touchless authentication procedure in response to voice input.

In one or more embodiments, a fingerprint sensor 204 is operable with the one or more processors 106. In one embodiment, the fingerprint sensor 204 includes its own associated processor to perform various functions, including detecting a finger touching the fingerprint sensor 204, capturing and storing fingerprint data from the finger, detecting user actions across a surface of the fingerprint sensor 204.

The processor can perform at least one pre-processing step as well, such as assigning a quality score to fingerprint data obtained from the fingerprint sensor 204 when the fingerprint sensor 204 scans or otherwise attempts to detect an object such as a finger being proximately located with the fingerprint sensor 204. This quality score can be a function of one or more factors, including the number of fingerprint features found in a scan or image, the signal to noise ratio of the scan or image, the contrast of the scan or image, or other metrics.

The one or more processors 106, or alternatively the processor associated with the fingerprint sensor 204, can then perform additional pre-authentication steps as well, including determining whether the quality score falls below a predefined threshold. Where it does, the one or more processors 106 or the processor associated with the fingerprint sensor 204 can conclude that any object adjacent to the fingerprint sensor 204 and being scanned by the fingerprint sensor 204 is likely not a finger. Accordingly, the one or more processors 106 or the processor associated with the fingerprint sensor 204 can preclude the fingerprint data from consideration for authentication. In one or more embodiments, the one or more processors 106 or the processor associated with the fingerprint sensor 204 can additionally increment a counter stored in memory 107 to track the number and/or frequency of these “low quality score” events.

Where the quality score is sufficiently high, the fingerprint sensor 204 or its associated processor (where included) can deliver fingerprint data to the one or more processors 106. In one or more embodiments the processor of the fingerprint sensor 204 can optionally perform one or more preliminary authentication steps where the quality score is sufficiently high, including comparing fingerprint data captured by the fingerprint sensor 204 to a reference file stored in memory 107. The processor of the fingerprint sensor 204 can be an on-board processor. Alternatively, the processor can be a secondary processor that is external to, but operable with, the fingerprint sensor in another embodiment. Other configurations will be obvious to those of ordinary skill in the art having the benefit of this disclosure.

In one embodiment, the fingerprint sensor 204 can include a plurality of sensors. The fingerprint sensor 204 can be a complementary metal-oxide-semiconductor active pixel sensor digital imager or any other fingerprint sensor. The fingerprint sensor 204 can be configured to capture, with the plurality of sensors, a live scan of a fingerprint pattern from a finger disposed along its surface, and to store this information as fingerprint data from the user's finger. The fingerprint sensor 204 may also be able to capture one or more images with the plurality of sensors. The images can correspond to an area beneath a surface of skin. The fingerprint sensor 204 can compare the fingerprint data or skin images to one or more references to authenticate a user in an authentication process.

Various sensors and other components 208 can be operable with the one or more processors 106. A first example of a sensor that can be included with the other components 208 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 106, to detect an object in close proximity with—or touching—the surface of the display 203 or the housing of an electronic device 100 by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

Another example of a sensor that can be included with the other components 208 is a geo-locator that serves as a location detector 210. In one embodiment, location detector 210 is able to determine location data when the touchless authentication process occurs by capturing the location data from a constellation of one or more earth orbiting satellites, or from a network of terrestrial base stations to determine an approximate location. Examples of satellite positioning systems suitable for use with embodiments of the present invention include, among others, the Navigation System with Time and Range (NAVSTAR) Global Positioning Systems (GPS) in the United States of America, the Global Orbiting Navigation System (GLONASS) in Russia, and other similar satellite positioning systems. The satellite positioning systems based location fixes of the location detector 210 autonomously or with assistance from terrestrial base stations, for example those associated with a cellular communication network or other ground based network, or as part of a Differential Global Positioning System (DGPS), as is well known by those having ordinary skill in the art. The location detector 210 may also be able to determine location by locating or triangulating terrestrial base stations of a traditional cellular network, such as a CDMA network or GSM network, or from other local area networks, such as Wi-Fi networks.

Other components 208 operable with the one or more processors 106 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 208 can also include proximity sensors. The proximity sensors fall in to one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 201 of the electronic device 100. In one embodiment, the signal receiver is an infrared signal receiver to receive an infrared emission from an object such as a human being when the human is proximately located with the electronic device 100. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about ten feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 106 can cause each proximity sensor component to operate at a first “effective” sensitivity so as to receive infrared emissions from a first distance. Similarly, the one or more processors 106 can cause each proximity sensor component to operate at a second sensitivity, which is less than the first sensitivity, so as to receive infrared emissions from a second distance, which is less than the first distance. The sensitivity change can be effected by causing the one or more processors 106 to interpret readings from the proximity sensor component differently.

By contrast, proximity detector components include a signal emitter and a corresponding signal receiver. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light pulses that reflect from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

A context engine 213 can then operable with the various sensors to detect, infer, capture, and otherwise determine persons and actions that are occurring in an environment about the electronic device 100. For example, where included one embodiment of the context engine 213 determines assessed contexts and frameworks using adjustable algorithms of context assessment employing information, data, and events. These assessments may be learned through repetitive data analysis. Alternatively, a user may employ the user interface 202 to enter various parameters, constructs, rules, and/or paradigms that instruct or otherwise guide the context engine 213 in detecting multi-modal social cues, emotional states, moods, and other contextual information. The context engine 213 can comprise an artificial neural network or other similar technology in one or more embodiments.

In one or more embodiments, the context engine 213 is operable with the one or more processors 106. In some embodiments, the one or more processors 106 can control the context engine 213. In other embodiments, the context engine 213 can operate independently, delivering information gleaned from detecting multi-modal social cues, emotional states, moods, and other contextual information to the one or more processors 106. The context engine 213 can receive data from the various sensors. In one or more embodiments, the one or more processors 106 are configured to perform the operations of the context engine 213.

In one or more embodiments, the electronic device 100 incudes a facial biometric authenticator 221. In one or more embodiments, the facial biometric authenticator 221 includes an imager 211, a depth imager 212, and a thermal sensor 213. In one embodiment, the imager 211 comprises a two-dimensional imager configured to receive at least one image of a person within an environment (103) of the electronic device 100. In one embodiment, the imager 211 comprises a two-dimensional RGB imager. In another embodiment, the imager 211 comprises an infrared imager. Other types of imagers suitable for use as the imager 211 of the authentication system will be obvious to those of ordinary skill in the art having the benefit of this disclosure.

The thermal sensor 213, which is optional, can also take various forms. In one embodiment, the thermal sensor 213 is simply a proximity sensor component included with the other components 208. In another embodiment, the thermal sensor 213 comprises a simple thermopile. In another embodiment, the thermal sensor 213 comprises an infrared imager that captures the amount of thermal energy emitted by an object. Other types of thermal sensors 213 will be obvious to those of ordinary skill in the art having the benefit of this disclosure.

The depth imager 212 can take a variety of forms. Turning briefly to FIG. 3, illustrated therein are three different configurations of the facial biometric authenticator 221, each having a different depth imager (212).

In a first embodiment 301, the depth imager 304 comprises a pair of imagers separated by a predetermined distance, such as three to four images. This “stereo” imager works in the same way the human eyes do in that it captures images from two different angles and reconciles the two to determine distance.

In another embodiment 302, the depth imager 305 employs a structured light laser. The structured light laser projects tiny light patterns that appear larger with distance as an example. Alternatively, the depth imager 305 could project different patterns and/or encoding. These patterns land on a surface, such as a user's face, and are then captured by an imager. By determining the location and spacing between the elements of the pattern, or the type of pattern, three-dimensional mapping can be obtained.

In still another embodiment 303, the depth imager 306 comprises a time of flight device.

Time of flight three-dimensional sensors emit laser or infrared pulses from a photodiode array. These pulses reflect back from a surface, such as the user's face. The time it takes for pulses to move from the photodiode array to the surface and back determines distance, from which a three -dimensional mapping of a surface can be obtained. Regardless of embodiment, the depth imager 304,305,306 adds a third “z-dimension” to the x-dimension and y-dimension defining the two -dimensional image captured by the facial biometric authenticator 221, thereby enhancing the security of using a person's face as their password in the process of authentication by facial recognition.

Turning back to FIG. 2, the facial biometric authenticator 221 can be operable with a face analyzer 219 and an environmental analyzer 214. The face analyzer 219 and/or environmental analyzer 214 can be configured to process an image or depth scan of an object and determine whether the object matches predetermined criteria. For example, the face analyzer 219 and/or environmental analyzer 214 can operate as an identification module configured with optical and/or spatial recognition to identify objects using image recognition, character recognition, visual recognition, facial recognition, color recognition, shape recognition, and the like. Advantageously, the face analyzer 219 and/or environmental analyzer 214, operating in tandem with the facial biometric authenticator 221, can be used as a facial recognition device to determine the identity of one or more persons detected about the electronic device 100.

Illustrating by example, in one embodiment when the facial biometric authenticator 221 detects a person, one or both of the imager 211 and/or the depth imager 212 can capture a photograph and/or depth scan of that person. The facial biometric authenticator 221 can then compare the image and/or depth scan to one or more reference files stored in the memory 107. This comparison, in one or more embodiments, is used to confirm beyond a threshold authenticity probability that the person's face—both in the image and the depth scan—sufficiently matches one or more of the reference files.

Beneficially, this optical recognition performed by the facial biometric authenticator 221 operating in conjunction with the face analyzer 219 and/or environmental analyzer 214 allows access to the electronic device 100 only when one of the persons detected about the electronic device are sufficiently identified as the owner of the electronic device 100. Accordingly, in one or more embodiments the one or more processors 106, working with the facial biometric authenticator 221 and the face analyzer 219 and/or environmental analyzer 214 can determine whether at least one image captured by the imager 211 matches a first predefined criterion, whether at least one facial depth scan captured by the depth imager 212 matches a second predefined criterion, and—where included—whether the thermal energy identified by the thermal sensor 213 matches a third predefined criterion, with the first criterion, second criterion, and third criterion being defined by the reference files and predefined temperature range. The first criterion may be a skin color, eye color, and hair color, while the second criterion is a predefined facial shape, ear size, and nose size. The third criterion may be a temperature range of between 95 and 101 degrees Fahrenheit. In one or more embodiments, the one or more processors 106 authenticate a person as an authorized user of the electronic device when the at least one image matches the first predefined criterion, the at least one facial depth scan matches the second predefined criterion, and the thermal energy matches the third predefined criterion.

Additionally, in or more embodiments the imager 211 and/or depth imager 212 is configured to capture multiple images and/or multiple depth scans. In one or more embodiments, the face analyzer 219 and/or environmental analyzer 214 is configured to detect movement of the person between the first image and the second image. Movement can include motion of the person while remaining in the same location, e.g., a change in facial expression, a touch of the cheek, a new orientation of the electronic device relative to the user, and so forth. Motion can include blinking, opening or closing the mouth, raising the eyebrows, changing posture, moving the head relative to the neck, and so forth.

Examples of movement can also include both the person moving in three-dimensional space and movement of the person's features. One example might be removing the user's glasses while walking between images or depth scans. Another example might be winking while changing the distance between the user and the electronic device 100 between images or depth scans. Still another example might be blowing out one's cheeks while stepping backwards between images or depth scans. These are illustrations only, as other examples of movement will be obvious to those of ordinary skill in the art having the benefit of this disclosure.

In one or more embodiments, the face analyzer 219 can also include an image/gaze detection-processing engine. The image/gaze detection-processing engine can process information to detect a user's gaze point. The image/gaze detection-processing engine can optionally also work with the depth scans to detect an alignment of a user's head in three -dimensional space. Electronic signals can then be delivered from the imager 211 or the depth imager 212 for computing the direction of user's gaze in three-dimensional space. The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes.

In one or more embodiments, the face analyzer 219 is further configured to detect mood. The face analyzer 219 can infer a person's mood based upon contextual information received from the imager 211 and/or depth imager 212. For example, if a picture, a depth scan, multiple successive pictures, multiple successive depth scans, video, or other information from which a person can be identified as the owner of the electronic device 100 indicate that the owner is crying, the face analyzer 219 can infer that she is either happy or sad.

The face analyzer 219 can similarly determine emotion in one or more embodiments. Illustrating by example, a picture, a depth scan, multiple successive pictures, multiple successive depth scans, video, or other information relating to of the owner of an electronic device can allow the inference of their silently communicated emotional state, e.g. joy, anger, frustration, and so forth. This can be inferred from, for example, facial gestures such as a raised eyebrow, grin, or other feature. In one or more embodiments, such emotional cues can be used as a secret password for authentication in addition to the face.

In one or more embodiments, the electronic device 100 includes an encryptor 217 that is operable with the one or more processors 106. The encryptor 217 can encrypt private data (108) using an encryption key 220 that is a function of a seed 215. The encryptor can include an encryption key generator 218 that generates the encryption keys as a function of the seed 215. The encryptor 217 can also decrypt private data (108) as a function of the encryption key 220 as well.

The seed 215 used to generate the encryption keys can be a combination or function of multiple factors. As noted above, in one or more embodiments the electronic device 100 is assigned a random number 220 that serves as the basis of the seed 215. However, this random number 220 can be combined with other data to generate the encryption key.

In one or more embodiments, the seed 215 comprises a combination of the random number 220 assigned to the electronic device 100 and data representations corresponding to unique characteristics of an authorized user. Examples of such characteristics include fingerprint, iris features, facial shape, skin tone, hair color, eye color, facial mapping in three dimensions, voice profile, and other factors. In addition to these unique characteristics, one or more embodiments of the disclosure employ non-biometric information, such as a personal identification number (PIN), a user's location, and so forth. Thus, embodiments of the disclosure require not only access to the seed 215, but that a particular authorized user both be biometrically authenticated and deliver a second authentication factor to the device prior to any private data being revealed.

In one or more embodiments, upon receiving a request (109) to expose the private data (108), the one or more processors 106 obtain at least one biometric authentication factor (111) and at least one second authentication factor (112) as described above with reference to FIG. 1. The one or more processors 106 then confirm the at least one biometric authentication factor (111) and the at least one second authentication factor (112) each match a predefined criterion as previously described.

In one or more embodiments, when the at least one biometric authentication factor (111) and the at least one second authentication factor (112) each sufficiently match the predefined criterion, data representations thereof can be combined with the random number 220 to generate the seed 215. Accordingly, the encryptor 217 can then generate an encryption key from the seed 215 using the encryption key generator 218, and can use the encryption key when decrypting the private data (108). In one or more embodiments, the seed is a function of a random number 220 assigned to the electronic device 100. In one or more embodiments, the encryption key is further a function of one or more of the at least one biometric authentication factor (111) or the at least one second authentication factor (112).

Referring now to both FIGS. 2 and 4, in one or more embodiments, only the encryptor 217, which is physically present in the electronic device 100, can encrypt or decrypt the private data (108) stored in the private data store 215. In one or more embodiments, the electronic device 100 is assigned the truly random number 220, which is used to generate the seed 215. The authorized user 401 has unique biometric characteristics, such as facial shape 402, facial features 403, iris features 404, fingerprints, and so forth.

Where the private data (108) is to be decrypted for use within the electronic device 100, in one or more embodiments the encryptor 217 only requires the seed 215 for decryption. However, in one or more embodiments any exposure of the private data (108), such as presenting the private data (108) on the display 203, requires a seed 215 that is a combination of the random number 220 and the unique biometric characteristics.

Accordingly, the encryptor 217 can then generate an encryption key from the seed 215 using the encryption key generator 218, and can use the encryption key when decrypting the private data (108). In one or more embodiments, the seed 215 is a function of a random number 220 assigned to the electronic device 100. This seed 215 is used for decryption of the private data (108) for use within the electronic device 100 when exposure is not required. However, in one or more embodiments the encryption key is further a function of one or more of the at least one biometric authentication factor (111) or the at least one second authentication factor (112). This seed 215 can be used for decryption of the private data (108) when exposure of the same is required. In one or more embodiments, this encryption data resides only within the private data store 215 of the memory 107 of the electronic device 100.

Advantageously, this system allows for uploading the private data (108) to the cloud for training or other purposes using only the seed 215 that is a function of the random number 220. However, if a person wishes to expose the private data (108) for any purpose, they must have access to the electronic device 100 and must be authenticated with the at least one biometric authentication factor (111) or the at least one second authentication factor (112). This means that only the authorized user 401 can reveal private data (108).

In one or more embodiments, if an unauthorized user gets access to the electronic device 100, the failure of the at least one biometric authentication factor (111) or the at least one second authentication factor (112) to be authenticated causes the one or more processors 106 to perform one of several actions. In one embodiment, the seed 215 can be disabled, thereby preventing the encryptor 217 from decrypting the private data (108). Optionally, the one or more processors may elevate the level of authentication, requiring additional biometric authentication factors prior to re-enabling the seed 215.

In another embodiment, when one or more of the at least one biometric authentication factor (111) and the at least one second authentication factor (112) fail match the predefined criterion, the one or more processors 106 are operable to lock the electronic device 100 for at least a predefined duration. For instance, the one or more processors 106 may lock the electronic device 100 for a period of five minutes.

In another embodiment, when one or more of the at least one biometric authentication factor (111) and the at least one second authentication factor (112) fail match the predefined criterion, the one or more processors 106 may require capture of at least a third authentication factor (120). Alternatively, the one or more processors 106 may require capture of at least one higher security factor or both biometric type factor, or may require an additional depth scan for front and side and in between. The one or more processors 106 may then preclude exposure of the private data (108) unless the at least a third authentication factor (120) matches another predetermined criterion. For example, the one or more processors may require a fingerprint scan or an iris scan in addition to a facial depth scan before revealing the private data (108).

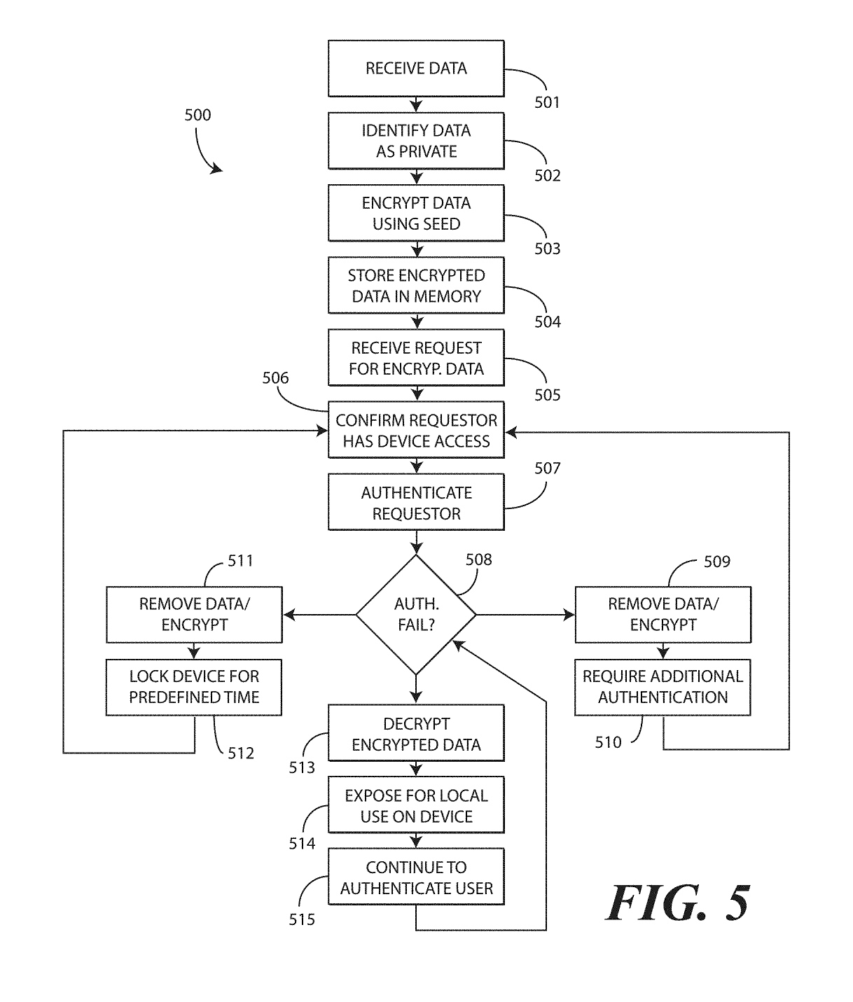

Turning now to FIG. 5, illustrated therein is one explanatory method 500 for an electronic device in accordance with one or more embodiments of the disclosure. At step 501, the method 500 receives data. This data can be received with a communication circuit, directly from a user interface, or by other techniques.

At step 502, the method 500 identifies the data as private data. This step 502 can be performed in a number of ways. In one embodiment, a user designates the data as private data. The user may enter the data through the user interface and flag the data is private. In another embodiment, one or more processors of the electronic device may be programmed to presume certain data is private data. For instance, the one or more processors may be configured to identify entered passwords, social security numbers, user profile information, or other information as private data. Other techniques for identifying data as private data at step 502 will be obvious to those of ordinary skill in the art having the benefit of this disclosure.

At step 503, the method 500 encrypts the private data using a seed. The private data can be encrypted in multiple ways in one or more embodiments. For example, in one embodiment the electronic device is assigned a random number. This random number can be used to generate a seed with which the private data can be encrypted or decrypted for use only within the electronic device, and without exposure of the private data.

However, in one embodiment step 503 includes encrypting the private data with another seed that is a combination of the random number and at least one biometric authentication factor or the at least one second authentication factor. When the private data is required to be exposed, decryption with a seed that is a function of the random number and at least one biometric authentication factor or the at least one second authentication factor can be required. Thus, at step 503, the private data can be encrypted with various levels of encryption. At step 504, the encrypted private data is stored within a memory that resides locally within the electronic device.

At step 505, the method 500 receives, at a user interface, a request to expose private data that is encrypted and stored within a memory carried by the electronic device. In one or more embodiments, if a person wishes to expose the private data for any purpose, they must have access to the electronic device and must be authenticated. At step 506, the method 500 determines whether the person has physical access to the electronic device. In one or more embodiments, this step 506 comprises obtaining at least one biometric authentication factor from a user. Examples of biometric authentication factors include capturing RGB images captured of a requestor, capturing facial depth scans of a requestor, capturing fingerprint scans of a requestor, capturing voice information of a requestor, capturing an iris scan of a requestor, and so forth. Other examples of how physical access to the electronic device can be determined will be obvious to those of ordinary skill in the art having the benefit of this disclosure.

Step 505 can further comprise obtaining at least one second authentication factor as well. Examples of the second authentication factor can include a pin code, a password, or other information identifying the requestor.

At step 506, the method 500 authenticates the requestor as an authorized user of the electronic device. Said differently, in one embodiment step 507 comprises identifying a predetermined user, i.e., an authorized user, within a local environment of the electronic device as the requestor. This step 507 can occur in a variety of ways.

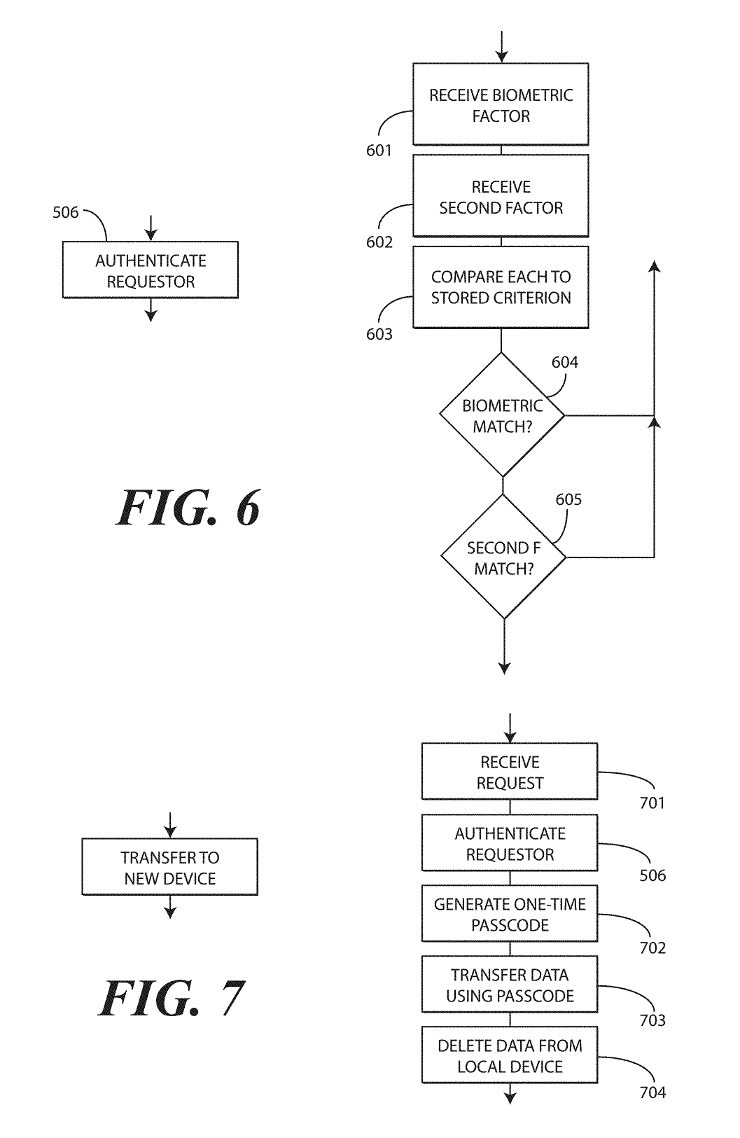

Turning briefly to FIG. 6, illustrated therein is one way step 507 can occur. Beginning at step 601, step 507 comprises obtaining, with a biometric sensor, at least one biometric authentication factor from a local environment of the electronic device. Illustrating by example, in one embodiment the at least one biometric authentication factor comprises a facial authentication obtained from one or more images of the predetermined user and a facial depth scan of the predetermined user. Other biometric authentication factors have been described above. Still others will be obvious to those of ordinary skill in the art having the benefit of this disclosure.

Step 602 comprises obtaining, with another sensor, at least one second authentication factor from the local environment of the electronic device. In one embodiment, the at least one second authentication factor comprises a passcode. In another embodiment, the at least one second authentication factor comprises audio matching a predefined audio signature of the predetermined user. Other second authentication factors have been described above. Still others will be obvious to those of ordinary skill in the art having the benefit of this disclosure.

At decision 604, one or more processors of the electronic device determine whether the at least one biometric authentication factor matches one or more predefined criteria. At decision 605, the one or more processors determined whether the at least one second authentication factor matches one or more other predefined criteria. Where both the at least one biometric authentication factor and the at least one second authentication factor match the predefined criteria, the method (500) returns to decision (508) of FIG. 5.

Turning now back to FIG. 5, at decision 508, the method 500 determined whether authentication was successful. As noted above, this occurs in one embodiment where both the at least one biometric authentication factor and the at least one second authentication factor match the predefined criteria.

Where the authentication is unsuccessful, various actions can be taken to prevent unauthorized individuals from gaining access to the private data. Illustrating by example, where either the at least one biometric authentication factor or the at least one second authentication factor fail to match the predefined criteria, step 509 or step 511 can include encrypting the decrypted private data by retrieving an encryption key from an encryption store of the memory carried by the electronic device.

In one embodiment, shown at step 510, the method 500 can include requiring capture of at least a third authentication factor and precluding the exposing of the private data unless the at least a third authentication factor matches another predetermined criterion. In another embodiment, shown at step 512, the method 500 can include locking the device and/or precluding the exposure of the private data for a predefined duration, such as ten minutes, thirty minutes, 12 hours, or 24 hours, and so forth. Step 512 can optionally include precluding the transfer of the decrypted private data to remote electronic devices as well.

However, where both the at least one biometric authentication factor and the at least one second authentication factor match the predefined criteria, the method moves to step 513. In one embodiment, step 513 comprises decrypting the encrypted private data. Step 514 then comprises exposing, locally on the electronic device with the one or more processors, the private data as decrypted private data.

In one or more embodiments, the identity of the authorized user can be continuously authenticated. Accordingly, if an authorized user initially gains access to the private data, but then has the electronic device “snatched” from their hands, the continuous authentication will fail, thus causing exposure of the private data to cease. This occurs at optional step 515.

In one or more embodiments, step 515 comprises, while the decrypted private data is exposed, continuing the obtaining of the at least one biometric authentication factor, the obtaining the at least one second authentication factor, and the determining whether the at least one biometric authentication factor and the at least one second authentication factor match the predefined criteria. In one or more embodiments, at any time where either the at least one biometric authentication factor or the at least one second authentication factor fail to match the predefined criteria, step 515 can move to either step 509 or step 511, which causes a cessation of the exposure of the private data as the decrypted private data.

Turning now to FIG. 7, illustrated therein is a method 700 for transferring private data from one device to another. As noted above, embodiments of the disclosure contemplate that it may be necessary to transfer private data from one device to another. For example, if a user has private data stored in a smartphone and buys a newer model, they may desire to transfer the private information to the new device.

Beginning at step 701, the method 700 receives, with a user interface or other device, a request to transfer the private data to a remote electronic device. At step 506, 506, in one embodiment the method 700 authenticates the requestor of the transfer as an authorized user as previously described with reference to FIG. 6.

At step 702, a one-time password to access the private data is generated. In one embodiment, this is generated with a passcode generator operable in the electronic device. In another embodiment, the one-time password is obtained from the authorized user at a user interface. The authorized user may type in the one-time password on a keypad or virtual keypad, for example

At step 703, in one embodiment the method 700 transfers the private data with a communication circuit to the new device. In one or more embodiments, step 703 comprises transferring the private data only after the one of generating or the obtaining the one-time password at step 702. At optional step 704, the private data can be deleted in the transferring device. The authorized user can then use and/or reveal the private data on the new device via entry of the one-time password. Advantageously, where the private data is to be transferred from one device to another, a one-time user generated passcode can be created that allows an authorized user to access the private data on the other device provided they have physical access to the other device.

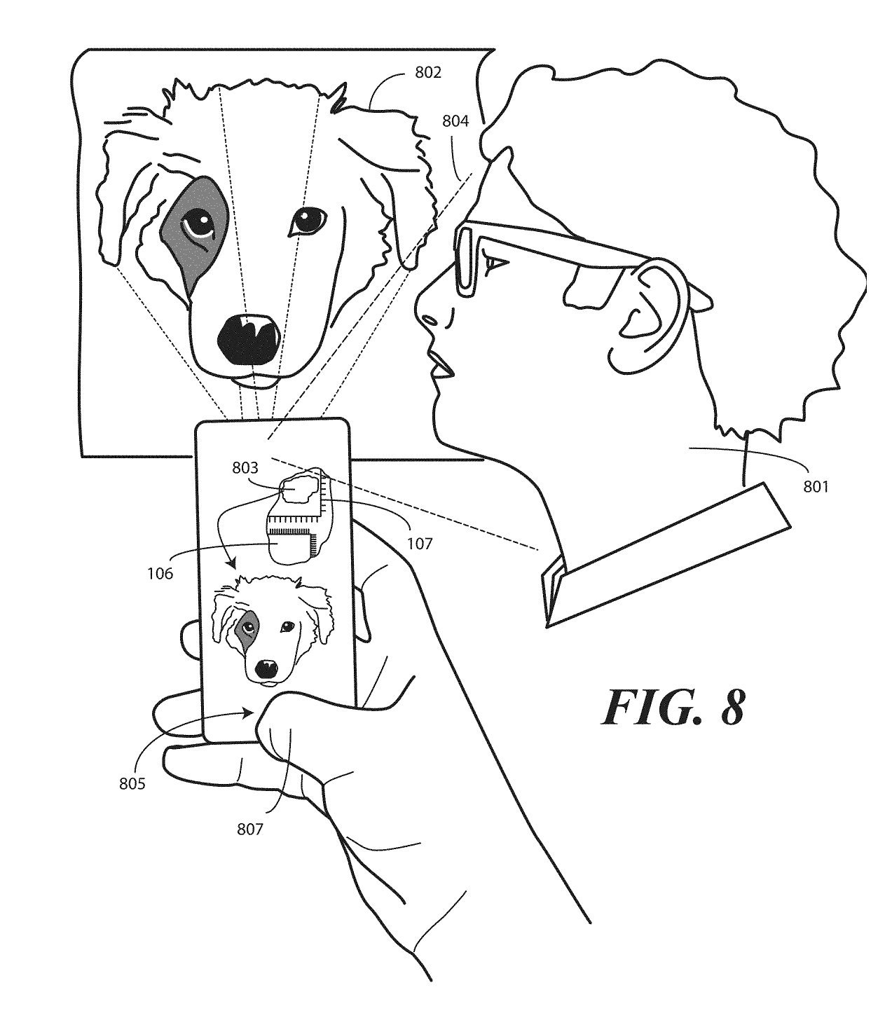

Turning now to FIG. 8, illustrated therein are one or more method steps in accordance with one or more embodiments of the disclosure. AS shown, private data 108 is stored within a memory 107 of an electronic device 100 as encrypted private data 803. An authorized user 801 requests the encrypted private data 803 be revealed as decrypted private data 802. In this example, the authorized user 801 wishes to project a picture of his dog, Buster, on a screen.

In one or more embodiments, one or more processors 106 of the electronic device 100 decrypt the encrypted private data 803 for use locally on the electronic device 100 only when a biometric authentication factor received by a biometric sensor carried by the electronic device 100 matches a first predefined criterion and a second authentication factor received by another sensor carried by the electronic device 100 matches a second predefined criterion.

In some embodiments, the biometric authentication factor comprises a facial depth scan 804 and the second authentication factor comprises entry of a passcode. However, in other embodiments the second authentication factor can comprise another biometric authentication factor. For example, in this illustrative embodiment the second authentication factor comprises a fingerprint scan 805.

In this illustrative embodiment, the biometric authentication factor and the second authentication factor are checked continually. Thus, the face 806 of the authorized user 801 is continually scanned, and the authorized user 801 must continually keep their finger 807 on the fingerprint scanner for the private data 108 to be exposed.

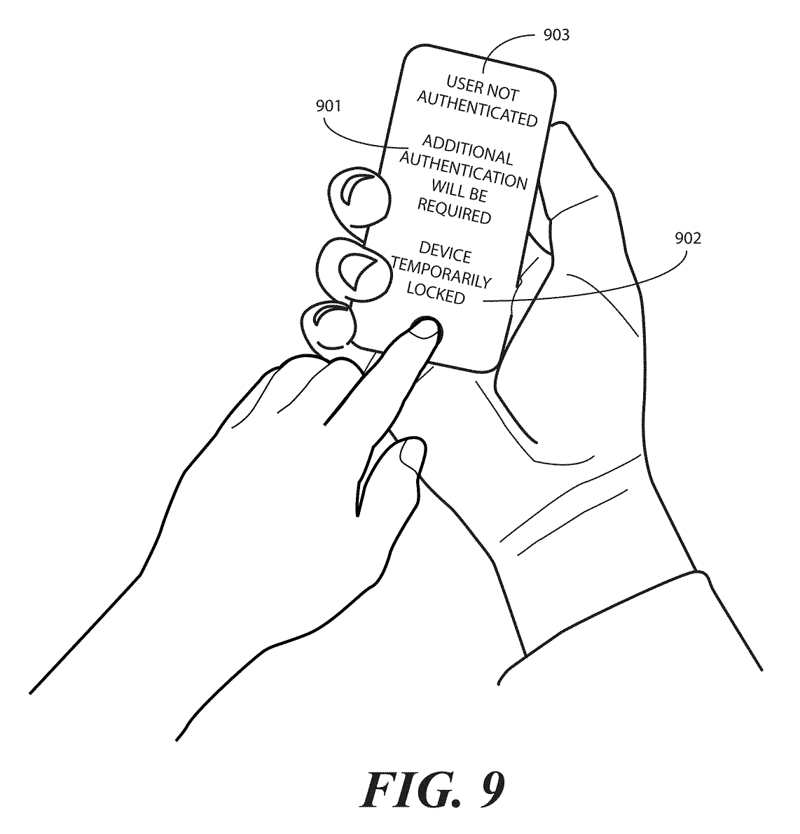

If, at any time, the biometric authentication factor received fails to match the first predefined criterion or the second authentication factor fails to match the second predefined criterion, exposure of the private data 108 will cease. Turning now to FIG. 9, additional steps to access the private data may be required.

Illustrating by example, in one embodiment the electronic device 100 may require at least a third authentication factor 901 to match a third predefined criterion prior to the decrypting the private data (108). In another embodiment, the electronic device 100 may be locked 902 for a predefined amount of time. OF course, combinations of these actions can occur. Other actions where a user fails to be authenticated 903 as an authorized user will be obvious to those of ordinary skill in the art having the benefit of this disclosure.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method, in an electronic device, the method comprising:
receiving, with a user interface, a request to expose private data encrypted and stored within a memory carried by the electronic device;
identifying a predetermined user, within a local environment of the electronic device, as a requestor of the request by:
obtaining, with a biometric sensor, at least one biometric authentication factor from the local environment of the electronic device; and
obtaining, with another sensor, at least one second authentication factor from the local environment of the electronic device;
determining, with one or more processors, whether the at least one biometric authentication factor and the at least one second authentication factor match predefined criteria; and
where both the at least one biometric authentication factor and the at least one second authentication factor match the predefined criteria, exposing, locally on the electronic device with the one or more processors, the private data as decrypted private data.

2. The method of claim 1, wherein the at least one biometric authentication factor comprises a facial authentication obtained from one or more images of the predetermined user and a facial depth scan of the predetermined user.

3. The method of claim 2, wherein the at least one second authentication factor comprises a passcode.

4. The method of claim 3, wherein the at least one second authentication factor comprises audio matching a predefined audio signature of the predetermined user.

5. The method of claim 1, further comprising:
while the decrypted private data is exposed, continuing:
the obtaining of the at least one biometric authentication factor;
the obtaining the at least one second authentication factor; and
the determining whether the at least one biometric authentication factor and the at least one second authentication factor match the predefined criteria; and
where either the at least one biometric authentication factor or the at least one second authentication factor fail to match the predefined criteria, ceasing the exposing of the private data as the decrypted private data.

6. The method of claim 5, further comprising, where either the at least one biometric authentication factor or the at least one second authentication factor fail to match the predefined criteria, encrypting the decrypted private data by retrieving an encryption key from an encryption store of the memory carried by the electronic device.

7. The method of claim 1, further comprising, where either the at least one biometric authentication factor or the at least one second authentication factor fail to match the predefined criteria, requiring capture of at least a third authentication factor and precluding the exposing unless the at least a third authentication factor matches another predetermined criterion.

8. The method of claim 1, further comprising, where either the at least one biometric authentication factor or the at least one second authentication factor fail to match the predefined criteria, precluding the exposing for a predefined duration.

9. The method of claim 1, further comprising:
receiving, with the user interface, a request to transfer the private data to a remote electronic device;
one of generating, with a passcode generator, or obtaining, from the user interface, a one-time password to access the private data;
transferring the private data, with a communication circuit, the private data to the remote electronic device only after the one of generating or the obtaining the one-time password.

10. The method of claim 1, further comprising receiving, with the user interface, a request to transfer the private data to a remote electronic device, and precluding the transfer of the decrypted private data to remote electronic devices unless both the at least one biometric authentication factor and the at least one second authentication factor match the predefined criteria.

11. An electronic device, comprising:
at least one biometric sensor, at least one additional sensor, and a user interface;
one or more processors operable with the at least one biometric sensor and the user interface; and
a memory, carried by the electronic device and operable with the one or more processors, the memory storing private data as encrypted private data;
the one or more processors receiving, from the user interface, a request to expose the private data locally on the electronic device;
the one or more processors, in response to the request, identifying a requestor as a predetermined user by
obtaining:
at least one biometric authentication factor with the at least one biometric sensor; and
at least one second authentication factor from the at least one additional sensor; and
confirming:
the at least one biometric authentication factor and the at least one second authentication factor each match a predefined criterion;
wherein when the at least one biometric authentication factor and the at least one second authentication factor each match the predefined criterion the one or more processors exposing the private data locally on the electronic device.

12. The electronic device of claim 11, further comprising an encryptor, operable with the one or more processors, the encryptor decrypting the encrypted private data prior to the one or more processors exposing the private data.

13. The electronic device of claim 12, the encryptor generating an encryption key from a seed and using the encryption key when decrypting the encrypted private data.

14. The electronic device of claim 13, wherein the encryption key is a function of a random number assigned to the electronic device.

15. The electronic device of claim 14, wherein the encryption key is further a function of one or more of the at least one biometric authentication factor or the at least one second authentication factor.

16. The electronic device of claim 12, wherein when one or more of the at least one biometric authentication factor and the at least one second authentication factor fail match the predefined criterion the one or more processors lock the electronic device for at least a predefined duration.

17. The electronic device of claim 12, wherein when one or more of the at least one biometric authentication factor and the at least one second authentication factor fail match the predefined criterion the one or more processors requiring capture of at least a third authentication factor and precluding the exposing unless the at least a third authentication factor matches another predetermined criterion.

18. A method, comprising:
identifying, with one or more processors of an electronic device, received data as private data;
encrypting, with an encryptor, the private data with a random number seed to obtain encrypted private data;
storing, with the one or more processors, the encrypted private data in a memory carried by the electronic device; and
decrypting the encrypted private data for use locally on the electronic device only when:
a biometric authentication factor received by a biometric sensor carried by the electronic device matches a first predefined criterion; and
a second authentication factor received by another sensor carried by the electronic device matches a second predefined criterion.

19. The method of claim 18, wherein the second authentication factor comprises another biometric authentication factor.

20. The method of claim 19, wherein when the biometric authentication factor received fails to match the first predefined criterion or the second authentication factor fails to match the second predefined criterion, requiring at least a third authentication factor to match a third predefined criterion prior to the decrypting.
